(19) United States
(12) Patent Application Publication
(10) Pub. No.: US 2007/0231780 A1
(43) Pub. Date: Oct. 4, 2007

(54) System and method for interactive learning on a video platform

(75) Inventor: Brian Shulman, Birmingham, AL (US)

Correspondence Address: MH2 TECHNOLOGY LAW GROUP, 1951 KIDWELL DRIVE, SUITE 550, TYSONS CORNER, VA, 22182, US

(73) Assignee: Learning Through Sports

(21) Appl. No.: 11/390,347

(22) Filed: Mar. 28, 2006

(51) Int. Cl. G09B 3/00

(52) U.S. Cl. 434/350

(57) ABSTRACT

In accordance with an embodiment of the invention, there is a method for interactive learning. The method can comprise displaying a first question related to a chosen category in a first round and instituting steps (a) and (b) where step (a) is providing a first set of answer choices corresponding to the first question, wherein the set of answer choices comprises at least one correct answer to the first question and step (b) is receiving a selected answer choice. The method can also include initiating a video game for a predetermined period of time on the display in response to the selected answer choice being the at least one correct answer and proceeding to a second round after the predetermined period of time and providing a remedial lesson corresponding to the subject matter of the first question in response to the selected answer choice not being he at least one correct answer. Further, the method can include displaying a second question after the remedial lesson related to the category, receiving a second selected answer, and initiating the video game for the predetermined period of time on the display in response to the second selected answer being the at least one correct answer; otherwise proceeding to the second round. Still further, the method can comprise starting the second round by displaying a third question on the display and repeating the steps (a) and (b) and generating a report based on a record of the questions and the corresponding chosen answers, wherein the report is provided to an instructor.

### DESCRIPTION OF THE INVENTION

1. Field of the Invention

The subject matter of this application relates to systems and methods to assist in education. More particularly, the subject matter of this application relates to systems and methods that use interactive teaching and video game rewards on a computer to promote learning.

2. Background of the Invention

One problem associated with education is keeping students motivated to learn. Typical instruction involves a teacher in a classroom lecturing before a group of students. Students passively listen to the lecture, which may be followed by homework lessons. Using this conventional methodology, which has been used for many generations, it is difficult to keep students motivated to pay attention to the lecture and. to follow through with assigned lesson. Moreover, it can be difficult for the teacher to monitor the progress that the student achieves through homework lessons. In particular, it is difficult or impossible for the teacher to know the subject matter where the student is having problems. Still further, because the teacher may have many students, it is difficult or impossible to provide each student with remedial lessons related to each concept being taught in a course.

Thus, there is a need to overcome these and other problems of the prior art associated with teaching. In particular, there is a need to provide a system and method that can keep a student motivated to learn. In addition, there is a need to provide a system and method that can provide remedial lessons to students on the nuances with various subject matters. Still further, there is a need to provide a system and method to provide a teacher with information about their students' strengths and weaknesses.

### SUMMARY OF THE INVENTION

In accordance with an embodiment of the invention, there is a method for interactive learning. The method can comprise displaying a first question related to a chosen category in a first round and instituting steps (a) and (b) where step (a) is providing a first set of answer choices corresponding to the first question, wherein the set of answer choices comprises at least one correct answer to the first question and step (b) is receiving a selected answer choice. The method can also include initiating a video game for a predetermined period of time on the display in response to the selected answer choice being the at least one correct answer and proceeding to a second round after the predetermined period of time and providing a remedial lesson corresponding to the subject matter of the first question in response to the selected answer choice not being he at least one correct answer. Further, the method can include displaying a second question after the remedial lesson related to the category, receiving a second selected answer, and initiating the video game for the predetermined period of time on the display in response to the second selected answer being the at least one correct answer; otherwise proceeding to the second round. Still further, the method can comprise starting the second round by displaying a third question on the display and repeating the steps (a) and (b) and generating a report based on a record of the questions and the corresponding chosen answers, wherein the report is provided to an instructor.

According to various embodiments, also provided is a system for interactive learning. The system can comprise a database comprising a plurality of questions related to a plurality of categories and a plurality of correct answers and a plurality of incorrect answers corresponding to the plurality of questions. The system can also include a first network connection configured to (a) post on a display of a user a question related to a first category from the plurality of categories and a set of answers corresponding to the posted question to start a round of instruction, wherein the set of answers comprises at least one correct answer to the question and at least one incorrect answer to the question. The system can also include a second network connection configured to receive an answer chosen by the user and a processor configured to (b) determine whether the at least one correct answer is chosen, and if so, to initiate a video game for a predetermined period of time on the display and proceed to post on the display of the user a question related to the first category after the predetermined period of time. The processor can also be configured to provide a remedial lesson corresponding to the subject matter of the question when at least one of the correct answers is not chosen, post on the display of the user a revised question related to the question and a revised set of answers corresponding to the posted question, wherein the revised set of answers comprises at least one correct answer and at least one incorrect answer to the revised question, determine whether the at least one correct answer is chosen from the set of revised answers, and initiate the video game for the predetermined period of time on the display in the event that the at least one correct answer is chosen after the remedial lesson. Otherwise the processor can be configured to repeat (a) and (b). The processor can also be configured to generate a report based on the questions and corresponding chosen answers, wherein the report is provided to an instructor.

According to yet another embodiment, there is provided a computer readable medium comprising program code that configures a processor to perform a method for interactive learning. The computer readable medium can comprise program code for starting a first round by posting a first question related to a chosen category on a display. The computer readable medium can also include program code for (a) providing a first set of answer choices corresponding to the posted first question, wherein the set of answer choices comprises at least one correct answer to the first question and for (b) determining whether the at least one correct answer is chosen. The computer readable medium can also comprise program code for initiating a video game for a predetermined period of time on the display in the event that the at least one correct answer is chosen and proceeding to a second round after the predetermined period of time, otherwise, providing a remedial lesson corresponding to the subject matter of the first question when the at least one correct answer is not chosen. Also included can be program code for posting a second question after the remedial lesson related to the category, program code for determining whether the at least one correct answer is chosen, and initiating the video game for the predetermined period of time on the display in the event that the at least one correct answer is chosen after the remedial lesson, otherwise proceeding to the second round, and program code for starting the second round by posting a third question on the display and repeating the steps (a) and (b). Still further the computer readable medium can include program code for generating a report based on a record of the questions and the corresponding chosen answers, wherein the report is provided to an instructor.

It can be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a flow chart according to various embodiments that provides a method for interactive learning in accordance with the present teachings.

FIG. 2 is a representation of an interactive learning system in accordance with the present teachings.

FIG. 3 is a flow chart according to various embodiments that provides a method for interactive learning in accordance with the present teachings.

### DESCRIPTION OF THE EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of networked computer systems, and that any such variations do not depart from the true spirit and scope of the present invention. Moreover, in the following detailed description, references are made to the accompanying figures, which illustrate specific embodiments. Electrical, mechanical, logical, and structural changes may be made to the embodiments without departing from the spirit and scope of the present invention. The following detailed description is, therefore, not to be taken in a limiting sense and the scope of the present invention is defined by the appended claims and their equivalents.

According to various embodiments, systems and methods are provided that increase the motivation of users, such as a student, to practice and improve in education. In accordance with the present teachings, a student can be motivated to learn language arts, mathematics, or other subject matter through highly engaging state of the art web-based sports video games. The current teachings provide for a system that displays or prompts questions regarding state aligned curriculum in predetermined categories, such as language arts, mathematics, etc. and rewards the student for correct answers with playtime on sports video games. According to various embodiments, the system can provide teachers with reports detailing the progress of the student. For example, the system can provide a web-based reporting tool to provide teachers with information about areas where their students are doing well and where they are having difficulties. In some cases teachers can log onto the system or the system can provide a report to the teacher over the internet, such as by an electronic message.

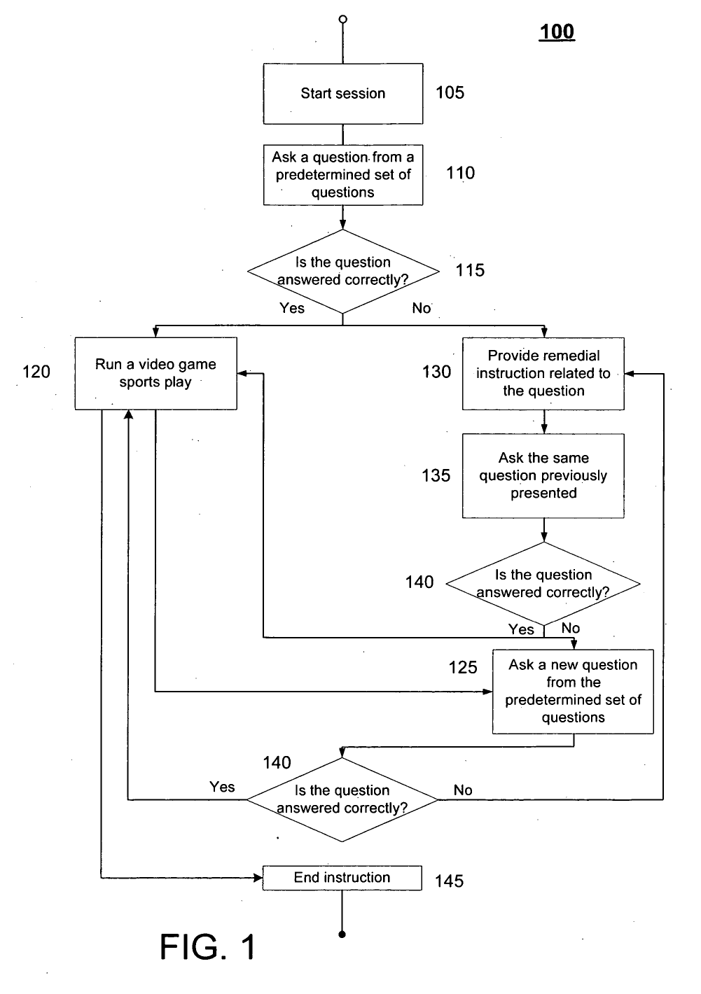

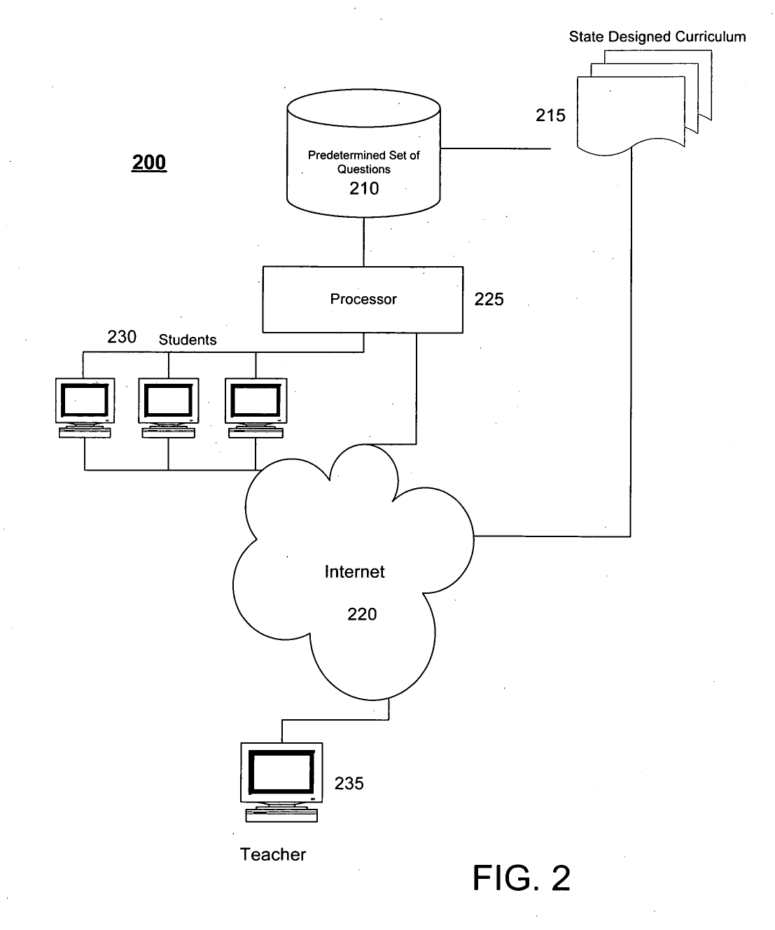

FIGS. 1-2 depict exemplary methods and systems for use in interactive learning in accordance with the present teachings. FIG. 1 illustrates a flowchart 100 that describes an embodiment of the invention. At 105, a user, such as a student, initially starts a session on an interactive learning system, such as system 200 shown in FIG. 2. Interactive learning system 200, which will be describe in further detail below, can comprise a database 210 that interacts with a curriculum repository 215 through a network 220, a processor 225 linked to a plurality of outputs 230, such as user displays, and linked to an instructor display 235.

Turning back to FIG. 1, in some cases the user may be required logon to the system by entering a user identification and a password that are authenticated and matched to a user profiles stored in database 210. The user profile can include unique indicators associated with the user, such as, for example, school, grade, class, skill level, previous areas of instruction, gender, race, free lunch status, native language, special educational status as well as other various indicators. After logging in, the system prompts the user to choose a particular category about which the user would like to learn. The user can also choose a video game they would like to play. Choices of categories can be, for example, areas of study presented in a school classroom, such as reading, language arts, or mathematics. It will be understood by one of ordinary skill in the art that the category can be any area of study.

At 110, the user is asked a question from a predetermined set of questions. The predetermined set of questions can be stored in database 210. According to various embodiments, the questions can be unique for each session. For example, a teacher may select individual skills (e.g., multiply fractions) to focus on or the teacher can select an entire content strands of skills (e.g., fractions), or an entire subject per grade. A processor, such as processor 225, can be used to adapt the questions based on the answer provided to a previous question(s). For example, the answer to a previous question(s) can be made to influence the next question to be asked. Moreover, successive questions can be made more difficult if the correct answer is given to the previous question. Similarly, successive questions can be made easier in instances where an incorrect answer is given to the previous questions.

The system can use an adaptive learning algorithm in determining questions to ask and to provide answer choices. According to various embodiments, the system can use defined thematic areas, herein called strands, in various subjects, such as mathematics and language arts to achieve the adaptive questioning. Each strand can include a set of sequenced skills that can server as bases for greater mastery of the subject matter by the student. A given strand, for example, geometry, can include related skills that can span multiple grade levels. With the adaptive questioning, successful students can remain interested in learning because they are continually moved up the strand sequence and presented with increasingly challenging skills. In this way, the student can attain their highest possible potential of mastery of the subject matter, even beyond that of their own grade level.

Moreover, the adaptive questioning allows struggling students avoid frustration because the system reduces the difficulty level until a point is reached at which mastery of the subject matter is possible. Upon mastering a particular level of the subject matter, struggling students can continue along the strand towards greater levels of mastery of the subject matter.

According to various embodiments, strands can be tracked for each student. In this manner, a student who is performing at an above-grade-level work in one area can be automatically presented with remedial level work in another area. Thus, the learning potential for each student can be maximized across subject areas.

Processor 225 can post questions on a user display, such a display 230. Processor 225 can also provide a first set of answer choices corresponding to the posted question. In some embodiments, the answer choices can be multiple choice answers where the choices include one correct answer. In other embodiments, there can be more that one correct answer choice presented or the answer choices can have varying degrees of correctness. Thus, the system can monitor the user's understanding of various aspects of the subject matter. In still further embodiments, the system may not provide answer choices. In such embodiments, the user may be required to describe an answer in their own terms, such as a fill-in-the blank format. In such cases, a processor could be used to search for key-words or phrases provided by the user. In other cases, the system could use intelligent software routines that could analyze the subject matter of the answers. The correctness could be evaluated based on an evaluation of the provided answer.

At 115, processor 225 can determine whether the user selected the correct answer from the first set of answer choices corresponding to the asked question. If the selected answer choice is the correct answer is chosen, processor 225 is programmed to unlock and/or initiate play on a video game on display 230 as a reward, at step 120. As an illustrative example, the question posted to display 230 could be: “How many planar sides are there on the surface of a square cube?” Processor 225 can also display the following answer choices: “(a) four (b) five (c) six (d) eight”. Choosing answer (c), the correct choice, unlocks the video game.

According to various embodiments, the video game can be a video sport game, such as football, baseball, basketball, volleyball, or any other game as will be understood by one of ordinary skill in the art. Moreover, the administrator can upload the logo and colors of a local elementary or high school or college or professional team (with permission) to provide a more realistic video game experience. When the video game is unlocked, it can be unlocked for a predetermined period of time before the lesson begins again, at step 125. For example, the user can be allowed to play the video game can from 5 to 30 seconds or the user can be allowed to play the video game for a set number of sport plays. The amount of that the user can be allowed to play the video game can be set by an administrator, such as the instructor, a school administrator, and/or the administrator of the interactive learning system.

According to various embodiments, the video game can provide three dimensional (3-D) graphics that allow the user to be more engaged with the game experience. According to various embodiments, the video games can be arcade style games where a player earns points by manipulating the on-screen player in each sport. As the player earns points they also unlock new features and more difficult levels within the games. In some cases there can be a time limit and numerous score multipliers. Each sport can be made available in either male or female mode.

In a football type game, the player can be a quarterback who has to hit a target to score points. Targets can start out stationary but the game can become more difficult as the player moves up in levels. In some cases, the targets start to run and then run faster with obstacles trying to block the pass. In a basketball type game, the player can be a shooter and has to sore baskets to score points. Defenders can try to block shots and the defender may become taller and faster as the game becomes more difficult. In a baseball type game, the player can be a batter and must hit a pitch from the pitcher to try and score points and home runs. Pitches can become more difficult as the game progresses. In a soccer type game, the player can be a shooter and must kick the ball past the goalie into the net to score goals and points. The goalie can becomes better as the game progresses and the soccer ball can start to move making it more difficult to kick. In a volleyball type game, the player can be an offensive scorer and must bat ball back and forth over net against opponent to score points. The opponent can become better at scoring and blocking shots as the game progresses.

Turning back to step 115, if the selected answer is not the correct answer, processor 225 is programmed not to unlock or initiate play on a video game. Rather, processor 225 is programmed to provide remedial instruction based on the subject matter of the asked question. Using the illustrative example presented above concerning a square cube, if an answer other than choice (c) is selected, such as choice (b), the remedial lesson is posted to the display 230. A remedial lesson in this case may include a lesson about cubes, surfaces, etc. in an effort to educate the user. According to various embodiments, the system can be programmed to provide printable remedial lessons. These lessons can be in provided for the student and/or the teacher to review.

After the remedial lesson, processor 225 can display a question, such as the same asked question: “How many planar sides are there on the surface of a square cube?” Processor 225 can also display the following answer choices: “(a) four (b) five (c) six (d) eight”. Choosing answer (c), the correct choice, unlocks the video game and play is initiated at step 120, as describe above. In some cases, processor may not display choice (b) as that incorrect choice was previously selected.

If it is determined that the correct answer is again not chosen in response to the asked question, processor 225 is programmed to not unlock, or initiate play on a video game. Rather, processor 225 is programmed to provide the correct answer and then ask a new question from the set of predetermined questions, at 125.

According to various embodiments, processor 225 can be programmed to unlock the video game when any number of questions are answered correctly. For example, processor 225 can be programmed to unlock the video game only when five questions are answered correctly. This feature can be programmed similar to how the predetermined amount of play time is programmed.

According to various embodiments, successive questions can adapt to the knowledge of the user. For example, each successive question can be made harder or easier depending on the answer provided to previous questions. Still further, processor 225 can adapt future questions to educate a user on areas of weakness as determined by the selected answers.

In accordance with the present teaching, the system can continue until the user, or some other entity stops the lesson, at 145. For example, a user may decide to stop the lesson after one hour of play. Processor 225 can store the information about the session of the user in database 210. For example, processor 225 can store the questions asked and the answers chosen in database 210. This information can be stored in a unique file associated with the user. This information can also be used to evaluate the progress of the user. In some embodiments, a summary of the strengths and weaknesses of the user in the various categories can be generated by processor 225. This summary can be provided to the instructor 235 over network 220. The summary can be used by the instructor to tailor future lessons to the user about various categories.

According to various embodiments, the system can interface with an established reporting system of a school or the school can run their own reports by interfacing with the system. Further, the system can provide auto email service where the system runs reports for the school or teacher and emails those reports to the customers, such as the school or teacher, each week. Various reports can be generated, such as reports at the school district level that can combine all school, classroom, and student data within a given school district. The information can be provided in numerous, such as, for example, by grade, skill, subject, ethnic/gender/free lunch status/special education, state standard, school, to name a few. The system can also provide reports for school principals as well as individual teachers. These reports can identify skill gaps, identify what questions were answered correctly and incorrectly and what time of day (during school hours, after school, at night from home, etc.) the student participated. The reports can also identify where teachers need to re-teach by identifying the areas where a student is struggling. From these reports the system can prescribe within the product what areas the student needs to review as well as actually place that student in that portion of the product.

Still further, database 210 can store information about where the user stopped in the video game. For example, database 210 can store where in the game the user left off, the score of a particular game, etc. As such, the user can continue to play the same game or can initiate a new game as desired in future sessions.

According to various embodiments, the system can allow multiple users to compete against each other, such as by video game score, number of correct questions, or various other metrics. For example, database 210 can store the score of a video game session(s) in the profile of a first user. Similarly, database can store the score of video game session(s) of a second user, such as a classmate of the first user. The various users can then compete against each other to obtain the high score.

In some embodiments, the session(s) can be open-ended or can last until an entire category or sub-category is taught. For example, in the category of mathematics, a sub-category could be “fractions”. The session(s) or games can continue until the subject of “fractions” has been taught and/or mastered by the user. In some cases, the session can last a school year or multiple school years, depending on, for example, the curriculum set up by the instructor, the complexity of the subject matter, the learning ability of the user, etc. It is envisioned, however, that the session can continue any length of time.

Turning to FIG. 2, system 200 will now be described. System 200 includes a database 210 that can store information about, for example, the categories to be taught and the user profiles. According to various embodiments, information about the categories to be taught can be regularly obtained from a predetermined curriculum, such as a state designed school curriculum. This information can be regularly updated by processor 225 accessing the curriculum over a network, such as the internet 220 through a network connection. Processor 225 can serve many functions, including generate and post questions and answers, analyze and evaluate the chosen answers, determine when the video game has been unlocked, run the video game, and compile and send the reports to the instructors 235.

System 200 can interface with at least one user display 230 through various network connections. In some cases the user displays 230 can be located at a school where the user regularly attends. Further, system 200 can interface with the displays 230 wherever the user has access over the network 220. Thus, the displays need not be considered part of the system. Rather, the displays can interact with system 200.

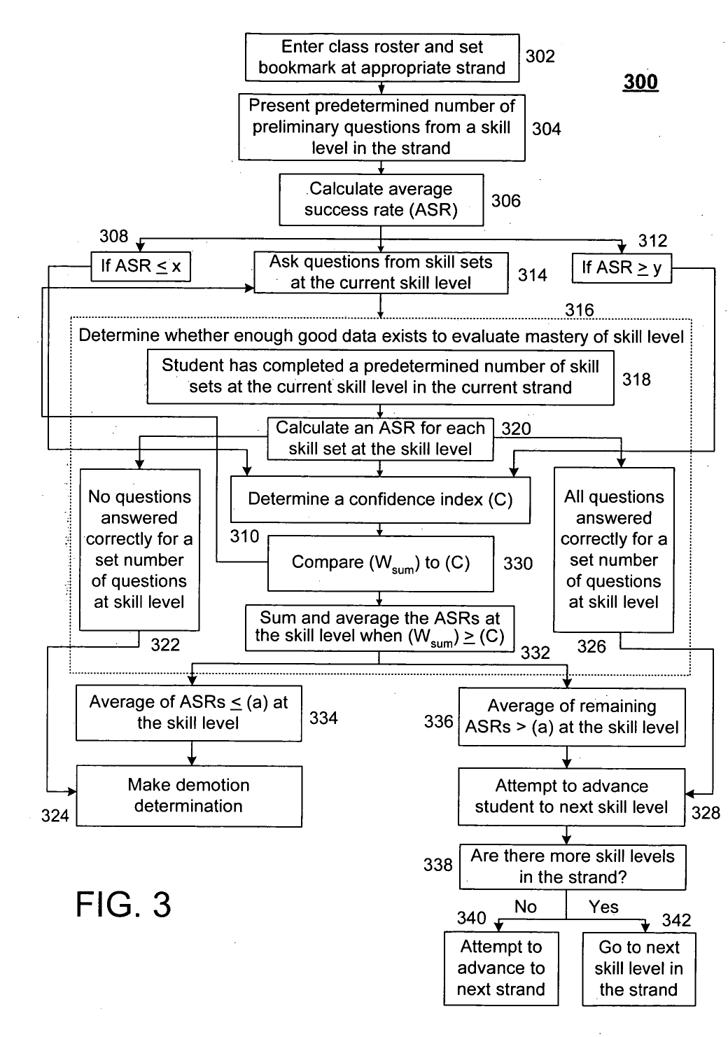

FIG. 3 shows a flow chart 300 of yet another embodiment in accordance with the present teachings. At 302, upon a student entering a class roster, a bookmark can be set in the system for the student in a strand that contains skill levels at the appropriate level or grade level for the student. A strand indicates a curriculum of education at a particular level or grade level. Skill levels indicate various concepts Within the particular strand and skill sets are sets of question used to educate a student at the skill level. Multiple strand can exist and stands can include multiple skill levels.

At 304, the system presents a predetermined number of preliminary questions corresponding to an “automatic content” skill set from a skill level in the bookmarked strand. For example, the “automatic content” skill set may have five questions. At 306, the system calculates an average success rate (ASR) for the skill set. The ASR is generally defined as the number of correct answers divided by the number of questions attempted. If the ASR is less than or equal to a predetermined percentage x, for example, x=30%, at 308, the student's work at the current skill level will hold and the system will determine whether the student will remain in the current strand or switch to another skill level or strand, at 310. This “early failure” notice allows for a “safety valve” to prevent failing students from being repeatedly asked questions that they cannot answer. If the ASR is greater than or equal to a predetermined percentage y, for example, y=90%, at 312, the student's work at the current skill level will also hold and the system will determine whether the student will remain in the current strand or switch to another skill level or strand, at 310. This “early mastery” notice also provides a “safety valve” for students who have already mastered the current skill level. In other cases, where x<ASR<y, the system continues to ask questions from the skill set at the current skill level, at 314.

At 316, the system attempts to determine whether enough good data exists to evaluate whether the student has mastery of a skill level. The decision to make this determination can be triggered when all of the questions in a current skill set or skill level have been exhausted at 318, or if an “early failure” or “early mastery” notice is posted, at 308 and 312, respectively. At 320, after the student has completed a predetermined number of skill sets, for example, four, at the current skill level in the current strand, the system calculates an ASR for each skill set for which questions were asked at the skill level. If a predetermined number of questions, such as all of the questions, were answered incorrectly, shown at 322, the system determines whether to demote the student to a different skill level or strand, shown at 324. Similarly, if a predetermined number of questions, such as all of the questions, were answered correctly, shown at 326, the system determines whether to advance the student to the next skill level or strand, shown at 328.

Alternatively, the system proceeds to determine a confidence index (C) for the current skill level, as shown at 310. For example, each of the last four skill sets completed by the student in a current skill level can be assigned a weight (W), which represents how much the system can trust the data. The sum of the weights (Wₛᵤₘ) is compared to a predetermined value of (C), at 330, and if (Wₛᵤₘ)≧(C), the system attempts to advance the student to the next level, at 332. Otherwise, the system will not attempt to advance the student at this time and the system proceeds to ask questions from the skill level, at 314.

In an illustrative example, skill sets that have five or more available questions are given a weight (W) of 1.0, which means that the results are totally trust-worthy. If the skill sets have fewer than 5 questions, a weight (W) can be assigned as follows, where n is the number of questions in the skill set and s is the student success rate in the skill set:

If (s ≧ 75%) or (s ≦ 25%) and:

If (n = 1), then W = 0.5
If (n = 2), then W = 0.75
If (n = 3), then W = 0.875
If (n = 4), then W = 0.9375

If (25% < s < 75%) and:

If (n = 2), then W = 0.5
If (n = 3), then W = 0.6
If (n = 4), then W = 0.75

If, for example, (C)=3.0 and (Wₛᵤₘ) for the past four skill sets attempted is 2.4, the system will not have confidence that enough data is present and will not attempt to advance the student. If (Wₛᵤₘ) for the past four skill sets attempted at the current skill level is 3.5, the system has confidence in the data and the ASRs for each skill set attempted at the current level are summed and averaged, at 332.

When (Wₛᵤₘ)≧(C) the system sums the ASRs and computes the average (a) for the ASRs over the number of skill sets attempted. If (a)<a predetermined value, such as 70%, as shown at 334, the system proceeds to determine whether the student should be demoted to a different skill level or strand, at 324. If (a)≧the value, in this case, 70%, as shown at 336, the system attempts to advance the student to the next skill level, as shown at 328. The system then determines if there are more skill levels remaining in the current strand, at 338. If no more levels exist, the system advances the student to the next strand at 340. If more levels exist, the system proceeds to the next skill level, at 342.

According to various embodiments, the determination to demote a student can proceed by a detailed analysis. For example, the system can determine whether the student has completed 75% of the skill sets in the current skill level or strand at the student's grade level or above. Here the student may have hit a wall in the current strand but may have also gotten far enough along in the system that the student should not be demoted. If this is the cases, the system can mark the strand as “completed” and attempt to move the student to a new strand. The system can attempt to find the next strand not marked “completed” that contains skill sets at the student's grade level. If no such strand can be found, the student's state will be “reset” and the student will begin the sequence over, such as from step 304. Otherwise, the system will set the bookmark to the new strand and start the student at the first skill set for the grade level.

If, however, the student is at the lowest grade level in the strand, the system will mark the strand as “completed” and attempt to move the student to a new strand, as describe above. In this case, the student cannot be demoted because the student is already at the bottom of the strand.

Further, if the student has previously been demoted to the same grade level that they are about to be sent, the system can mark the strand as “completed” and attempt to move the student to a new strand. Finally, if the above tests for demotion fail, the system can set the student to the first skill set in the next lowest skill level in the same strand.

According to various embodiments, the system can then generate a report for the teacher or other administrator based on the various evaluations shown in FIG. 3. This enables the teacher to accurately track the student as well as provide guidance for future lessons. In some embodiments, the report can provide a single grade adaptive assessment (SGAA) that can identify skill gaps or weaknesses for each student. In particular, the system can adaptively select a random set of questions in one grade level for a single category and ask those questions over a period of sessions. For example, the system may select about 260 questions to about 280 questions in mathematics and ask those questions over four, 30 minute sessions. The system can monitor the answer choices provided by the student to determine areas of weakness or a lack of understanding of the category. The report can detail the results of these questions for each student in the class of a teacher. The system can also be programmed to automatically provide the student with questions related to the weaknesses identified previously. This can continue until the student has mastered the areas of weakness. This then becomes an ongoing practice cycle. Based on a review of the report, the teacher can select areas for the student to be tested on. As such, the teacher can influence the questions that are asked of the student.

According to various embodiments, the report can provide a single topic adaptive assessment (STM) that can also identify skill gaps or weaknesses for each student. In this case, the system can adaptively select a random set of questions in one content strand, or multiple strands can be selected ask those questions over a period of sessions. For example, the system can select about 30 questions from a strand and ask those questions over a single 30 minute session. The system can monitor the answer choices provided by the student to determine areas of weakness or a lack of understanding of the category. The report can detail the results of these questions for each student in the class of a teacher. The system can also be programmed to automatically provide the student with questions related to the weaknesses identified previously. This can continue until the student has mastered the areas of weakness. This then becomes an ongoing practice cycle. Based on a review of the report, the teacher can select areas for the student to be tested on. As such, the teacher can influence the questions that are asked of the student.

According to still further embodiments, the systems provided herein provide an economic efficiency for users, such as teachers, schools, and school boards. In particular, teaching costs per student are reduced because multiple students can be tutored simultaneously and remotely by the system. Moreover, because the system provides immediate remedial lessons for each skill in which the student has difficulties, learning time, and thus teaching time are reduced. Further, the remedial lessons are tailored to each student, and the student is tutored until mastery is achieved, something almost impossible for a single teacher to accomplish. Moreover, the report generated by the system can save the teacher time determine areas students are having difficulties. With this information, the teacher can develop teaching plans to address common areas of weakness for the entire class, or the teacher can group students having common weaknesses. Indeed, this information can be aggregated over a single school or over an entire school district. The information can then be used to accurately develop future curriculum. Still further, the system capitalizes on the desire of the student to participate in the video game as a reward, which continually motivates participation.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the internet or other networks. Concrete examples of the foregoing include distribution of executable software program(s) of the computer program on a CD-ROM or via internet download. In a sense, the internet itself, as an abstract entity, is a computer readable medium. The same is true of computer networks in general.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.”

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for interactive learning, the method comprising:
displaying a first question related to a chosen category in a first round;
(a) providing a first set of answer choices corresponding to the first question, wherein the set of answer choices comprises at least one correct answer to the first question;
(b) receiving a selected answer choice;
initiating a video game for a predetermined period of time on the display in response to the selected answer choice being the at least one correct answer and proceeding to a second round after the predetermined period of time; and
providing a remedial lesson corresponding to the subject matter of the first question in response to the selected answer choice not being he at least one correct answer;
displaying a second question after the remedial lesson related to the category,
receiving a second selected answer; and
initiating the video game for the predetermined period of time on the display in response to the second selected answer being the at least one correct answer; otherwise proceeding to the second round;
starting the second round by displaying a third question on the display and repeating the steps (a) and (b); and
generating a report based on a record of the questions and the corresponding chosen answers, wherein the report is provided to an instructor.

2. The method for interactive learning according to claim 1, wherein there the at least one correct answer is only one correct answer.

3. The method for interactive learning according to claim 1, wherein the video gate is a sports video game.

4. The method for interactive learning according to claim 3, wherein the sports video game is displayed in 3-D.

5. The method for interactive learning according to claim 1, wherein category corresponds to an educational curriculum.

6. The method for interactive learning according to claim 1, wherein at least one of the second question and third question is generated based on the answer chosen to the first question.

7. The method for interactive learning according to claim 1 further comprising:
providing the record of the questions and the corresponding chosen answers over a network to a computer, wherein the computer analyzes the record to generate the report.

8. The method for interactive learning according to claim 1, wherein the video game is initiated only after more than one question is answered correctly.

9. A system for interactive learning, the system comprising:
a database comprising,
a plurality of questions related to a plurality of categories; and
a plurality of correct answers and a plurality of incorrect answers corresponding to the plurality of questions;
a first network connection configured to
(a) post on a display of a user a question related to a first category from the plurality of categories and a set of answers corresponding to the posted question to start a round of instruction, wherein the set of answers comprises at least one correct answer to the question an at least one incorrect answer to the question;
a second network connection configured to receive an answer chosen by the user;
a processor configured to
(b) determine whether the at least one correct answer is chosen, and if so, to initiate a video game for a predetermined period of time on the display and proceed to post on the display of the user a question related to the first category after the predetermined period of time,
the processor also configured to
provide a remedial lesson corresponding to the subject matter of the question when at least one of the correct answers is not chosen,
post on the display of the user a revised question related to the question and a revised set of answers corresponding to the posted question, wherein the revised set of answers comprises at least one correct answer and at least one incorrect answer to the revised question,
determine whether the at least one correct answer is chosen from the set of revised answers, and initiating the video game for the predetermined period of time on the display in the event that the at least one correct answer is chosen after the remedial lesson, otherwise the processor repeats (a) and (b); and
the processor also configured to generate a report based on the questions and corresponding chosen answers, wherein the report is provided to an instructor.

10. The system for interactive learning according to claim 9, wherein there the at least one correct answer is only one correct answer.

11. The system for interactive learning according to claim 9, wherein the video gate is a sports video game.

12. The system for interactive learning according to claim 11, wherein the sports video game is displayed in 3-D.

13. The system for interactive learning according to claim 9, wherein the plurality of categories correspond to an educational curriculum.

14. The system for interactive learning according to claim 9, wherein at least one of the revised question is generated based on the answer chosen to the first question.

15. A computer readable medium comprising program code that configures a processor to perform a method for interactive learning comprising:
program code for starting a first round by posting a first question related to a chosen category on a display;
program code for
(a) providing a first set of answer choices corresponding to the posted first question, wherein the set of answer choices comprises at least one correct answer to the first question; and
(b) determining whether the at least one correct answer is chosen, and
program code for initiating a video game for a predetermined period of time on the display in the event that the at least one correct answer is chosen and proceeding to a second round after the predetermined period of time, otherwise,
providing a remedial lesson corresponding to the subject matter of the
first question when the at least one correct answer is not chosen,
program code for posting a second question after the remedial lesson related to the category,
program code for determining whether the at least one correct answer is chosen, and initiating the video game for the predetermined period of time on the display in the event that the at least one correct answer is chosen after the remedial lesson, otherwise proceeding to the second round;
program code for starting the second round by posting a third question on the display and repeating the steps (a) and (b); and
program code for generating a report based on a record of the questions and the corresponding chosen answers, wherein the report is provided to an instructor.

16. The computer readable medium for interactive learning according to claim 15, wherein there the at least one correct answer is only one correct answer.

17. The computer readable medium for interactive learning according to claim 15, wherein the video gate is a sports video game.

18. The computer readable medium for interactive learning according to claim 17, wherein the sports video game is displayed in 3-D.

19. The computer readable medium for interactive learning according to claim 15, wherein the plurality of categories correspond to an educational curriculum.

20. The computer readable medium for interactive learning according to claim 15, wherein at least one of the revised question is generated based on the answer chosen to the first question.
